(19) United States
(12) Patent Application Publication
(10) Pub. No.: US 2006/0224453 A1
(43) Pub. Date: Oct. 5, 2006

(54) Goods purchasing system and method using online commodity coupon

(76) Inventors: Jung-Hee Ryu, Seoul (KR); Ki Wan Park, Seoul (KR)

Correspondence Address: Klaus P. Stoffel;Wolff & Samson, PC, One Boland Drive, West Orange, NJ, 07052, US

(21) Appl. No.: 11/395,789

(22) Filed: Mar. 31, 2006

(30) Foreign Application Priority Data
Mar. 31, 2005 (KR) 10-2005-0027173

(51) Int. Cl. G06Q 30/00

(52) U.S. Cl. 705/14

(57) ABSTRACT

Provided is a goods purchasing system using an online commodity coupon. The system comprises a first terminal, at least one communicatable second terminal, a commodity coupon server, and a franchise. The system is to provide a goods purchasing system and method using an online commodity coupon, in which the commodity coupon for exchanging for and purchasing only a specific goods is purchased online and transmitted to a different user, and the receiving user is authenticated in a corresponding franchise and is allowed to purchase a specific commodity, thereby making it possible to achieve a new concept of real trade management unlike a conventional cash concept of an online coupon.

This Nonprovisional application claims priority under 35 U.S.C. § 119(a) on Patent Application No. 10-2005-0027173 filed in Korea on Mar. 31, 2005, the entire contents of which are hereby incorporated by reference.

### BACKGROUND OF THE INVENTION

1. Field of the Invention

The present invention relates to a goods purchasing system and method using an online coupon, and more particularly, to a goods purchasing system and method using an online commodity coupon, in which a commodity coupon for exchanging for and purchasing a specific commodity is online issued and a franchise uses the commodity coupon to provide real goods corresponding to the commodity coupon.

2. Description of the Background Art

In general, a merchandise ticket is dealt offline but, due to network advancement, a concept of an electronic commodity coupon has been introduced to even the merchandise ticket.

For example, Korean Laid-Open Patent No. 10-2003-0038899 entitled “Commodity Ticket/Lottery Ticket Providing System and Method using ATM, and Recording Medium Storing Program Source”, discloses a technique of providing a merchandise ticket/lottery ticket using an automatic teller machine (ATM).

Korean Laid-Open Patent No. 10-2002-0048202 entitled “Lottery Ticket Selling Method using POS Equipment and System Thereof”, discloses a technique of printing and outputting a lottery ticket using a point of sales (POS).

However, since the ATM or POS uses a method of printing and outputting the merchandise ticket or the lottery ticket by paper, it is inconvenient to keep prints. Further, since the merchandise ticket or the lottery ticket is outputted only to a purchaser, the purchaser has to directly output and transmit the merchandise ticket or the lottery ticket in order to transmit the merchandise ticket or the lottery ticket to a third party. Therefore, there is a drawback of inconvenience in use.

Further, in the case of the ATM, since the purchaser should carry a credit card or a cash card to purchase the merchandise ticket, there is a drawback in that teenagers cannot use the ATM.

### SUMMARY OF THE INVENTION

Accordingly, an object of the present invention is to solve at least the problems and disadvantages of the background art.

An object of the present invention is to provide a goods purchasing system and method using an online commodity coupon, in which the commodity coupon for exchanging for and purchasing only a specific goods is purchased online and transmitted to a different user, and the receiving user is authenticated in a corresponding franchise and is allowed to purchase a specific commodity, thereby making it possible to achieve a new concept of real trade management unlike a conventional cash concept of an online coupon.

Another object of the present invention is to provide a goods purchasing system and method using an online commodity coupon, in which the commodity coupon is conveniently kept and used online, and which can be used by any user carrying a wireless terminal, and in which the commodity coupon issued online is authenticated and then processed to purchase a specific goods, thereby preventing the commodity coupon from being used by stealth, and allowing a user to easily use the authenticated commodity coupon through the wireless terminal without a separate device.

A further object of the present invention is to provide a goods purchasing system and method using an online commodity coupon, in which the online commodity coupon is designated to exchange for or purchase only a specific goods intended for purchase, thereby giving anticipation to a purchaser or a client and maximizing satisfaction for supplied goods.

To achieve these and other advantages and in accordance with the purpose of the present invention, as embodied and broadly described, there is provided a goods purchasing system using an online commodity coupon, the system comprising a first terminal, at least one communicatable second terminal, a commodity coupon server, and a franchise. The first terminal is registered to an online service, and purchases the commodity coupon that can exchange for or purchase only specific goods through the online service. The at least one communicatable second terminal receives the online commodity coupon from the first terminal. The commodity coupon server online provides a commodity coupon issuance service, databases a variety of information on the issued commodity coupon, and connects with the first terminal and the at least one second terminal through a communication network. The franchise connects with the commodity coupon server through the communication network and confirms effectiveness or noneffectiveness of the online commodity coupon received at the second terminal, and, after the effectiveness of the online commodity coupon is confirmed, supplies a specific commodity corresponding to the online commodity coupon to a user of the second terminal.

The online service is a homepage based community or one-person media service, a messenger service, and a portal service.

The online commodity coupon is purchased by any one of settlements based on a cyber money held by each purchaser through the online service, a credit card, and a mobile communication terminal.

The first terminal and the at least one second terminal are portable wireless terminals.

The first terminal is a wired/wireless terminal, and the at least one second terminal is a portable wireless terminal.

The online commodity coupon transmitted from the first terminal to the at least one second terminal is transmitted through the commodity coupon server.

The commodity coupon server comprises: a terminal information database comprising information on the franchise, information on the first and second terminal, and user identification and cyber money information; a commodity coupon information database, an authentication processing module, a commodity coupon transmitting module, and a purchase processing module. The terminal information database comprises information on the franchise, information on the first and second terminal, and user identification and cyber money information. The commodity coupon information database stores information on an authentication number of the issued online commodity coupon, transaction goods, and transaction money, based on information on the specific commodity. In the authentication processing module, upon receipt of the authentication number of the online commodity coupon from a communication terminal of the franchise, the received authentication number is compared with information stored in the commodity coupon information database and processing authentication of the online commodity coupon. The commodity coupon transmitting module connects with the authentication processing module and, upon issuance of the online commodity coupon, transmits the issued online commodity coupon to the terminal on the basis of terminal or second terminal information stored in the terminal information database. The purchase processing module connects with the authentication processing module, and processes purchase of goods in each franchise depending on authentication or nonauthentication of the online commodity coupon.

The commodity coupon server further comprises a login information database for, in order to confirm an owner of the online commodity coupon, storing inherent password information of the second terminal user and, in case where the user uses the online commodity coupon, performing selective user authentication.

The system further comprises a VAN (value added network) service provider server for enabling mutual communication through a VAN network between the commodity coupon server and the franchise.

In another aspect of the present invention, there is provided a goods purchasing method using an online commodity coupon, the method comprising a first step of purchasing, a second step of registering and receiving, a third step of purchaser's selecting, a fourth step of visiting, a fifth step of supplying, and a sixth step of transmitting and updating. In the first step, a purchaser previously registered to an online service purchases an online commodity coupon that can online exchange for and purchase only specific goods, through a communicatable terminal. In the second step, the purchased online commodity coupon registered to a commodity coupon server, and details information of a specific commodity that corresponds to the registered commodity coupon is received from the commodity coupon server. In the third step, the purchaser selects whether or not he/she transmits the registered online commodity coupon to other users. In the fourth step, the purchaser himself/herself or other users receiving the online commodity coupon from the purchaser visits a franchise and confirms effectiveness or noneffectiveness of the online commodity coupon. In the fifth step, as a result of confirming the effectiveness or noneffectiveness, if authentication of the online commodity coupon succeeds, a specific commodity is supplied by the franchise. In the sixth step, authentication result information and use information on the online commodity coupon is transmitted to and updated in the commodity coupon server.

When the purchaser purchases the online commodity coupon in the first step, he/she purchases the online commodity coupon by applying for a premium provided in the online service, or connects to a specific Web site connecting with the online service and directly purchases the online commodity coupon using a cyber money held by each purchaser, a credit card, and hand phone settlement.

The method further comprises the step of, when the purchaser transmits the online commodity coupon to other users in the third step, inputting a terminal telephone number of the user, or detecting information on a user previously registered to the commodity coupon server and transmitting the detected information to the terminal.

When the purchaser transmits the online commodity coupon to himself/herself or other users, an authentication number given to the online commodity coupon is transmitted from the commodity coupon server to the purchaser himself/herself or the user in a push form using a previously stored telephone number, or transmission or nontransmission of the online commodity coupon is transmitted in the push form and the authentication number of the online commodity coupon is confirmable in a pull form.

The fourth step of confirming whether or not the online commodity coupon is effective depends on whether or not the authentication number of the online commodity coupon transmitted to the purchaser himself/herself or the user is consistent with authentication number information databased in the commodity coupon server.

In case where the authentication number of the online commodity coupon is consistent, the online commodity coupon is updated in the commodity coupon server as being one-time authenticated and used, and an authentication message is transmitted from the commodity coupon server to the franchise, and after one-time authentication, in case where the same authentication number is transmitted to the commodity coupon server, an authentication failure message is transmitted to the franchise.

In the fifth step, the franchise subtracts transaction money for the specific commodity and distinguishably processes charge money as “0 won”.

The communication terminal is a POS (point of sales) or a VAN (value added network) terminal.

### BRIEF DESCRIPTION OF THE DRAWINGS

The invention will be described in detail with reference to the following drawings in which like numerals refer to like elements.

FIG. 1 is a conceptive view illustrating a goods purchasing system using an online commodity coupon according to the present invention;

FIG. 2 illustrates a goods purchasing system using an online commodity coupon according to an embodiment of the present invention;

FIG. 3 illustrates a goods purchasing system using an online commodity coupon according to another embodiment of the present invention;

FIG. 4 is a block diagram illustrating a commodity coupon server in the systems of FIGS. 2 and 3;

FIG. 5 is a flowchart illustrating a method for purchasing an online commodity coupon before purchasing goods according to the present invention;

FIG. 6 illustrates a detailed process of the method of FIG. 5;

FIG. 7 is a flowchart illustrating a process of purchasing goods using a purchased online commodity coupon according to the present invention; and

FIG. 8 is an example of a user screen displayed in transaction based on the process of FIG. 7.

### DETAILED DESCRIPTION OF PREFERRED EMBODIMENTS

Preferred embodiments of the present invention will be described in a more detailed manner with reference to the drawings.

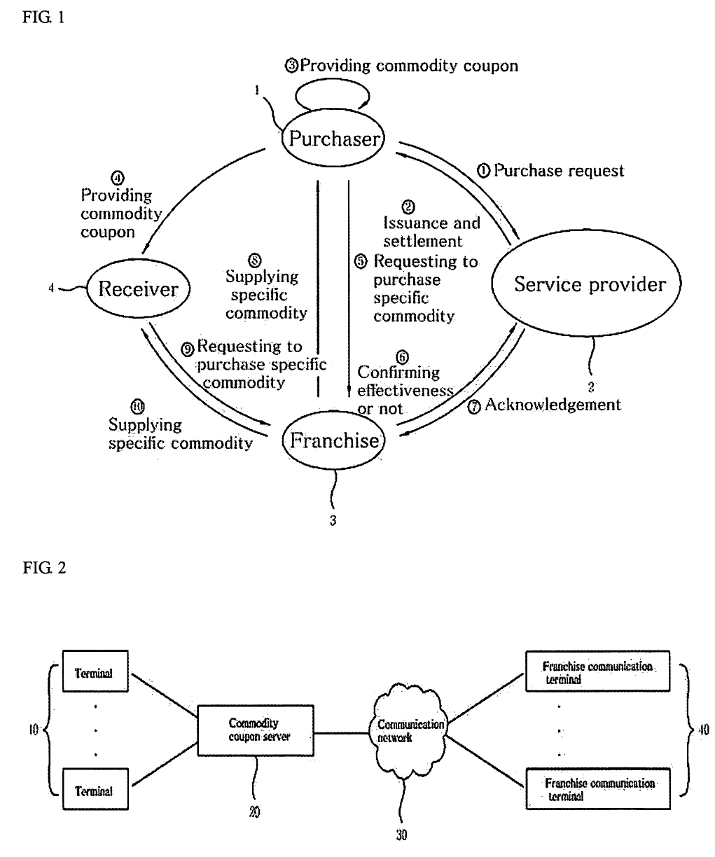

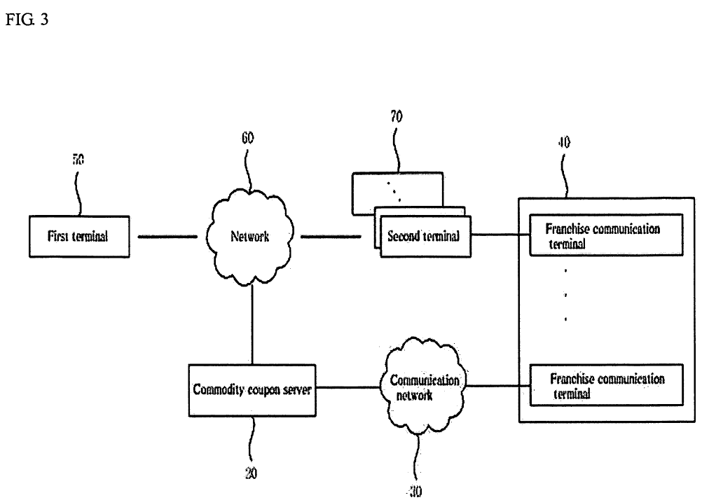

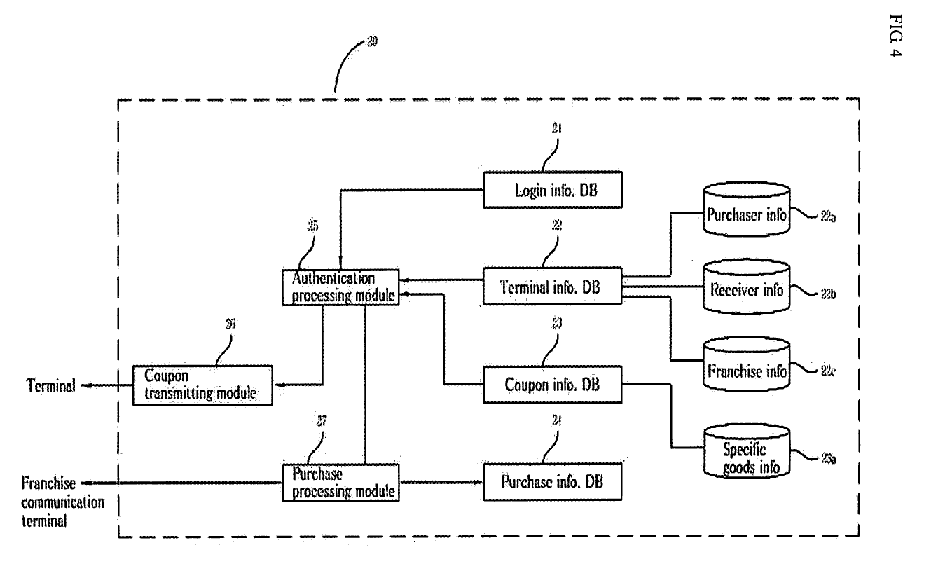

FIG. 1 is a conceptive view illustrating a goods purchasing system using an online commodity coupon according to the present invention, FIGS. 2 and 3 illustrate goods purchasing systems using online commodity coupons according to embodiments of the present invention, and FIG. 4 is a block diagram illustrating a commodity coupon server in the systems of FIGS. 2 and 3.

For reference, the same reference numerals will be used to refer to the same or like parts.

Referring to FIG. 1, the inventive goods purchasing system using the online commodity coupon comprises a purchaser 1, a commodity coupon issuance service provider 2, a franchise 3, and a receiver 4 which are connected with each other. For communication between the commodity coupon issuance service provider 2 and the franchise 3, the inventive system can further comprise a communication service provider server.

Here, the purchaser 1 refers to a person purchasing the commodity coupon online, the commodity coupon issuance service provider 2 refers to a service provider issuing the commodity coupon online and manages the same through a server, the franchise 3 refers to a shop making a predetermined contract with the commodity coupon issuance service provider 2 and supplying specific goods corresponding to the commodity coupon, and the receiver 4 refers to a person receiving the online purchased commodity coupon from the purchaser 1.

The online commodity coupon refers to a coupon for exchanging for or purchasing only the specific goods specified based on a predetermined contract made with the franchise 3. For example, there are a purchase coupon for purchasing a specified commodity such as home appliances (e.g. washing machine and microwave oven) and household supplies, a free coupon for seeing a specific movie, a taste coupon for tasting specific food, and a service coupon for using specific service (e.g. permanent, dyeing, and massage) provided from a beauty shop or a skin management enterprise.

The specific goods corresponding to the coupons can be provided in a type of the commodity such as home appliances or household supplies or the service such as food, permanent, or massage.

Accordingly, if the purchaser 1 requests for purchase of the commodity coupon in such a manner that he/she applies for a premium in an online service such as Web page based community or one-person media, messenger, and portal services, or that he/she directly purchases the commodity coupon through the Website linked with the online service , he/she requests the commodity coupon issuance service provider 2 to issue the online commodity coupon.

After that, the commodity coupon issuance service provider 2 online issues the commodity coupon to the purchaser 1 .

The online issued commodity coupon (Hereinafter, referred to as “online commodity coupon”) can be directly purchased by the purchaser 1 through the wireless terminal, and provided to the purchaser himself/herself , or can be provided to even other users by transmission to the receiver 4 other than the purchaser himself/herself in such a manner that the purchaser 1 online gives to the receiver 4 as a gift . In other words, the commodity coupon can be online transmitted from the purchaser 1 to the receiver 4.

The purchaser 1 or the receiver 4 receiving the online commodity coupon visits and requests the franchise 3 to purchase real goods corresponding to the online commodity coupon 6 and . The franchise 3 confirms whether or not the online commodity coupon provided from the purchaser 1 or the receiver 4 to the commodity coupon issuance service provider 2 is effective 6 and, upon receipt of acknowledgement from the commodity coupon issuance service provider 2, supplies the real goods to the purchaser 1 or the receiver 48 and .

For communication between the commodity coupon issuance service provider 2 and the franchise 3, a value added network (VAN) can be used. In this case, a VAN service provider server is further provided and connected.

In the inventive goods purchasing system using the online commodity coupon, two cases can be provided as shown in FIGS. 2 and 3 depending on purchaser 1 and receiver 4 subjects.

In other words, in case where the purchaser 1 and receiver 4 subjects are identical and the receiver 4 is the purchaser himself/herself, as shown in FIG. 2, the inventive system comprises a plurality of terminals 10; a commodity coupon server 20 connected over a network between the plurality of terminals 10, and issuing the online commodity coupon; and a plurality of franchise communication terminals 40 connected with the commodity coupon server 20 through a communication network 30.

The plurality of terminals 10, wired/wireless terminals such as a personal computer (PC), a notebook computer, a wireless phone, or a portable digital assistant (PDA) for communicating the commodity coupon server 20, allow the purchaser 1 carrying the terminal 10 to purchase the online commodity coupon from the commodity coupon server 20 and directly use the online commodity coupon in the franchise 3. Further, for use and carriage convenience of the online commodity coupon, the terminal 10 preferably is a portable wireless terminal.

In this case, the purchaser 1 requests the commodity coupon server 20 through the terminal 10 to issue the online commodity coupon, and after settlement, the purchaser 1 himself/herself receives and uses the online commodity coupon.

Meantime, in case where the purchaser 1 and receiver 4 subjects are different from each other, as shown in FIG. 3, the inventive system can comprise a first terminal 50; a second terminal 70 connected with the first terminal through a network 60; a commodity coupon server 20 connected with the first and second terminals 50 and 70 through the network 60; and a plurality of franchise communication terminals 40 connected with the commodity coupon server 20 through a communication network 30.

The first and second terminals 50 and 70 are wired/wireless terminals such as a personal computer (PC), a notebook computer, a wireless phone, or a portable digital assistant (PDA) which can communicate with each other over the network 60 and connect with commodity coupon server 20, and can be varied in combination. The first terminal 50 corresponds to the purchaser 1, and the second terminal 70 corresponds to the receiver 4.

For example, when the first terminal 50 is the PC and the second terminal 70 is the wireless terminal, the wireless terminal can receive the commodity coupon by selecting an option of “giving gift” to the second terminal 70 in the PC through a mini homepage/messenger.

Accordingly, the purchaser 1 carrying the first terminal 50 requests the commodity coupon server 20 to issue the online commodity coupon and, after settlement, transmits the online commodity coupon to the second terminal 70 of the receiver 4 so that the online commodity coupon can be provided to the receiver 4.

As described above, the first and second terminals 50 and 70 preferably are portable wireless terminals for use and carriage convenience of the online commodity coupon. The second terminal 70 can concurrently receive service from the first terminal 50 through a plurality of multi communications. The online commodity coupon received from the first terminal 50 cannot be used until it is authenticated from the plurality of franchise communication terminals 40.

Meanwhile, the purchaser 1 can purchase the commodity coupon by applying for the premium and winning a prize while already subscribing to and using the online service such as the Web page based community or one-person media, messenger, and portal services, or can connect to a predetermined Web site linked with the online service and directly select and purchase the commodity coupon.

For example, in case where the purchaser connects to a Web site that sells the online commodity coupon over Internet, the Web site preferably comprises and displays a list of specific transaction goods and information on the commodity coupon corresponding to the specific goods, so that the purchaser can easily select and accordingly, acquire the commodity coupon for the specific goods intended for purchase.

In case where the purchaser directly purchases the commodity coupon through the Web site as such, he/she uses various settlements such as use of cyber money or point held by each purchaser, and settlement based on a credit card or a hand phone.

As shown in FIG. 4, the commodity coupon server 20 comprises login information database (DB) 21; terminal information DB 22; a commodity coupon information DB 23; a purchase information DB 24; an authentication processing module 25; a commodity coupon transmission module 26; and a purchase processing module 27.

The login information DB 21 can comprise inherent password information of a user who intends to purchase goods by the online commodity coupon in the franchise 3, and confirm an owner of the online commodity coupon issued from the commodity coupon server 20. When the user uses the online commodity coupon in the franchise 3, user authentication can be selectively performed, thereby preventing the online commodity coupon from being used by stealth. The inherent password information can be previously connected and registered to the commodity coupon server 20 by the user, or can be directly inputted through the terminal 10 or the first and second terminals 50 and 70 after the online commodity coupon is received.

In the terminal information DB 22, communication terminal information at each franchise and a variety of information on the terminal 10 or the first and second terminals 50 and 70 of the user who purchases and receives the online commodity coupon through the commodity coupon server 20 is databased. The “variety of information” refers to information comprising telephone numbers of the terminal 10 or the first and second terminals 50 and 70, and user's identification and cyber money. Upon input of the identification from the terminal 10 or the first and second terminals 50 and 70, the information can be converted into the telephone number and online transmission of the online commodity coupon can be performed.

In the terminal information DB 22, purchase information 22a for purchasing the online commodity coupon through the commodity coupon server 20, receiver information 22b for receiving the online commodity coupon from the purchaser 1, and each franchise information 22c can be distinguishably databased. The receiver information 22b, and second terminal information at a receiver side can be selectively registered.

In the commodity coupon information DB 23, information on an authentication number for the online commodity coupon, transaction goods, transaction money, a transaction franchise, comprising each specific goods information 23a, are stored.

For example, if the online commodity coupon is a movie ticket for seeing a movie shown at a specific time in a specific movie theater, the specific goods information 23a has already databased information on showing time and theater and a title for a specific movie and, on the basis thereof, information on each authentication number of the commodity coupons, the showing theater designated to the transaction franchise, the title of the specific movie designated to the transaction goods, and the showing time can be distinguished and stored.

The purchase information DB 24 comprises a variety of information on user's purchase of the goods using the online commodity coupon.

The authentication processing module 25 confirms whether or not the online commodity coupon that can be used in the franchise 3 is effective, to provide the goods. Upon receipt of the authentication number for the online commodity coupon from the franchise communication terminal 40, the authentication processing module 25 compares the received authentication number with the information stored in the commodity coupon information DB 23 and processes authentication for the received online commodity coupon. In case where user login information is stored, when the online commodity coupon is used or is transmitted to other users, authentication is processed using the information stored in the login information DB 21.

The commodity coupon transmission module 26 connects with the authentication processing module 25 and transmits the online commodity coupon issued by user's request to the terminal 10 or the second terminal 70 of the receiver side, thereby providing the online commodity coupon to the purchaser himself/herself or other users.

The purchase processing module 27 connects with the authentication processing module 25, and processes purchasing of the goods in each franchise 3 depending on authentication or non-authentication of the online commodity coupon. The purchase processing module 27 real-time stores and updates the purchase information on the authentication-success online commodity coupon in the purchase information DB 24, and transmits and displays an authentication result of the purchase-completed online commodity coupon and purchase information thereof (e.g. the transaction goods, transaction money, transaction franchise information for the online commodity coupon) through the franchise communication terminal 40.

Meantime, the franchise communication terminal 40, a terminal installed at each franchise 3 and communicatable with the commodity coupon server 20, can employ VAN terminal or PC, a point of sales (POS), and a wireless terminal. As shown, the franchise communication terminal 40 connects with the commodity coupon server 20. Upon receipt of the authentication number for the online commodity coupon from the user, the franchise communication terminal 40 transmits the received authentication number to the commodity coupon server 20, receives the authentication result of the authentication number from the commodity coupon server 20, and displays the received authentication result so that the franchise can confirm the displayed authentication result.

Further, the franchise communication terminal 40 can real-time receive information list for the already databased specific goods from the commodity coupon server 20, and previously register the specific goods handled by each franchise and information on the commodity coupon of the specific transaction goods.

In other words, if the user (purchaser or receiver) holding the online commodity coupon visits the franchise 3 and shows the authentication number of his/her receiving online commodity coupon to a person in charge of the franchise 3, the person in charge inputs the authentication number through the franchise communication terminal 40 and transmits the authentication number to the commodity coupon server 20, and the commodity coupon server 20 compares the received authentication number with information previously stored in the commodity coupon information DB 23, performs an authentication process, and sends a reply of its resultant authentication result and information on the specific goods. At this time, the commodity coupon server 20 can transmit other confirmable information such as user telephone number, and the transaction goods and the transaction money for the online commodity coupon.

In case where a logoff function is set to the franchise communication terminal 40, after even a password of the franchise communication terminal 40 is inputted, the commodity coupon server 20 sends a reply of the authentication result and the goods information.

In the inventive goods purchasing system using the online commodity coupon, when the user uses the online service of the community or one-person media such as a homepage, or the messenger, he/she can purchase the online commodity coupon with the premium or the cyber money and transmit the purchased online commodity coupon to other users, and the other users can receive the online commodity coupon through wireless communication, be authenticated for the online commodity coupon in the franchise, and receive real goods corresponding to the authenticated online commodity coupon from the franchise.

Accordingly, the user can exchange for or purchase the specific commodity intended for purchase, using the online commodity coupon, in a similar manner that he/she purchases and gives as a gift a conventional online goods, that is, avatar clothes, a background screen, or a background music, and can easily transmit and authenticate the online commodity coupon to other users through the wireless terminal without a separate device. Therefore, there is an advantage in that keeping and use are convenient.

Further, the online commodity coupon can be designated to exchange for or purchase only the goods intended for purchase, thereby giving users' anticipation and maximizing users' satisfaction.

Hereinafter, in the goods purchasing system using the online commodity coupon, a method for purchasing the real goods using the online commodity coupon is as follows.

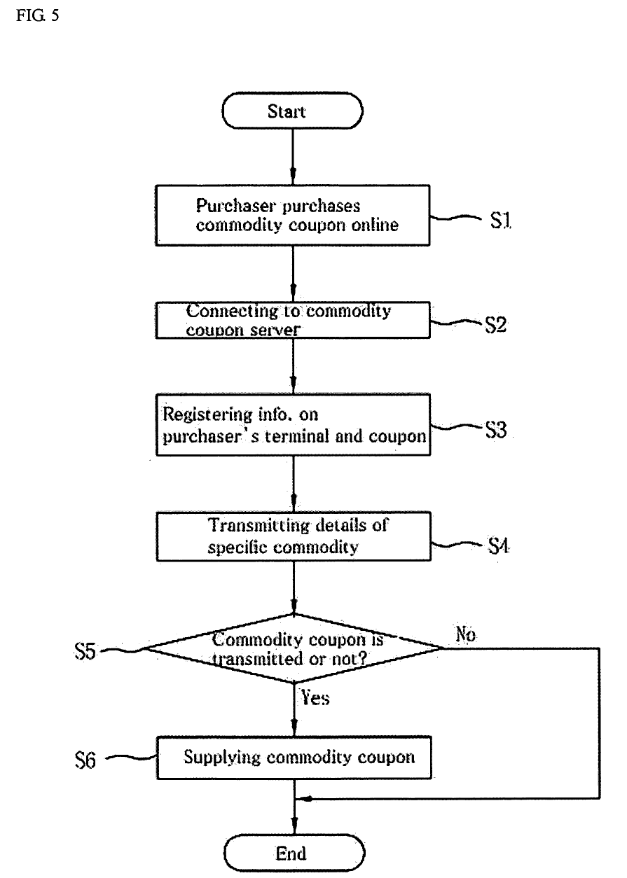

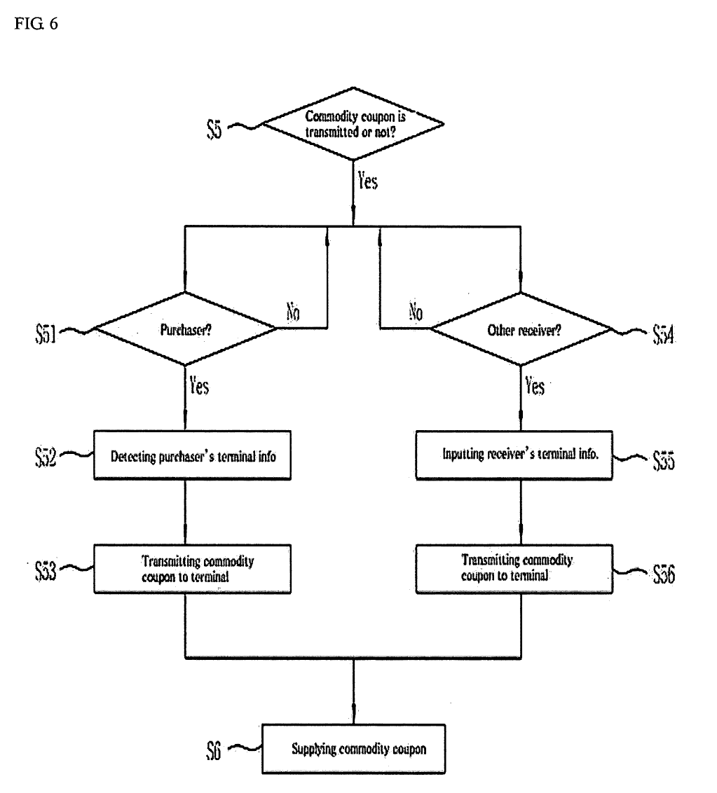

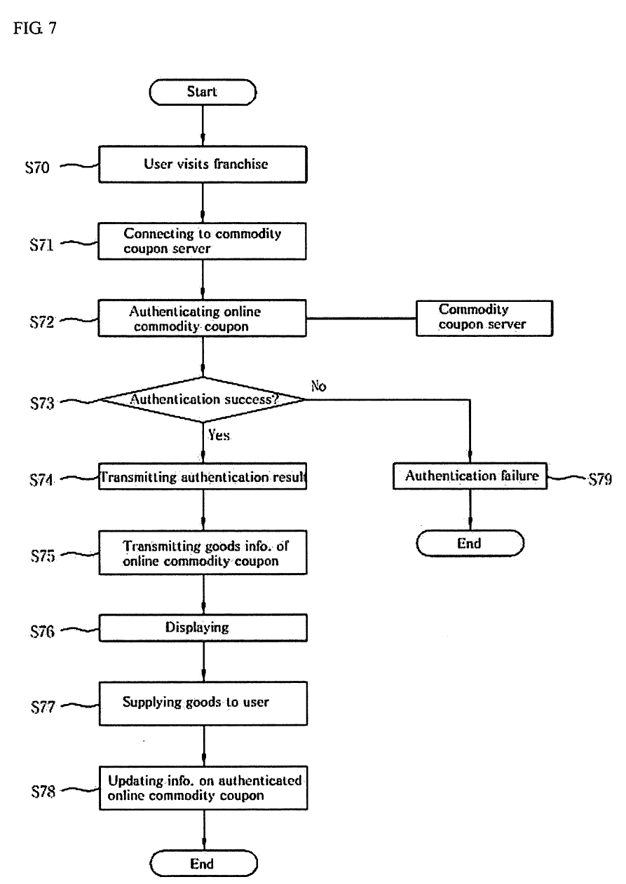

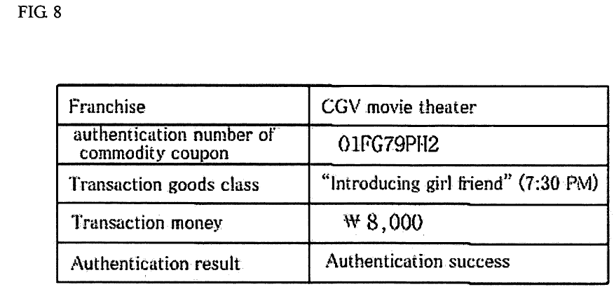

FIG. 5 is a flowchart illustrating a method for purchasing the online commodity coupon before purchasing the real goods according to the present invention, FIG. 6 illustrates a detailed process of the method of FIG. 5, FIG. 7 is a flowchart illustrating a process of purchasing the goods using the purchased online commodity coupon according to the present invention, and FIG. 8 is an example of a user screen displayed in transaction based on the process of FIG. 7.

<Purchasing and Registering of the Online Commodity Coupon>

Referring first to FIG. 5, the purchaser purchases the online commodity coupon, which can exchange for or purchase only the specific goods, through a communicatable terminal (Step 1).

The purchaser is previously registered to the online service such as the community or one-person media service, or the messenger service so that he/she can purchase the online commodity coupon by participating in applying for an event or premium provided through each online service, or purchase the online commodity coupon through his/her own holding cyber money based on the online service, the credit card, and the hand phone settlement.

In case where the online commodity coupon is purchased using the cyber money held by each purchaser, the cyber money corresponding to the online commodity coupon is subtracted and settled. In case where the online commodity coupon is purchased using the credit card or the hand phone, settlement is performed in such a manner that a fee is paid in connection with a separate settlement system.

The purchaser subjected to the above process is given a right for purchasing the goods corresponding to the purchased online commodity coupon. In order to register this right, the purchaser connects with the commodity coupon server and inputs information on the purchaser's terminal and the online commodity coupon (Steps 2 and 3).

After registration, the purchaser receives details information of a specific commodity corresponding to the purchased online commodity coupon, from the commodity coupon server to the terminal, and confirms the received details information (Step 4).

Subsequently, in case where the purchaser transmits the online commodity coupon to other users, he/she transmits and supplies the online commodity coupon to the other users in such a method that a transmit button is clicked or an icon or emoticon corresponding to the online commodity coupon is dragged on the user screen and, otherwise, the process is ended (Steps 4 to 6).

The “other user” refers to the purchaser who directly receives the online commodity coupon purchased by himself/herself, or the receiver who receives the online commodity coupon in such a method that the other person is given the gift. As shown in FIG. 6, it is first confirmed whether or not a subject of reception is the purchaser himself/herself and if so, in purchase, the purchaser's terminal information is detected and the online commodity coupon is transmitted to the terminal. Otherwise, the other receiver or not is confirmed (Steps 51 to 53).

If the subject of the reception is the other receiver than the purchaser himself/herself, the receiver's terminal information (telephone number) is separately inputted and the online commodity coupon is transmitted to the terminal and supplied to the receiver (Step 54 to 56). In case where the receiver's terminal information is previously registered to the online service, the identification used in the online service is inputted, and the terminal information is converted into the telephone number and is transmitted. In case where not registered to the online service, when the receiver receives the online commodity coupon, he/she can connect to a Web site in a method of a call-back short message service (SMS) and directly register the identification.

In other words, the receiver side has a feature of unlimited member subscription.

As such, when the online commodity coupon is transmitted, its authentication number given from the commodity coupon server is transmitted to the terminal in a push form such as a SMS or a multimedia messaging service (MMS). Or, the transmission or nontransmission of the online commodity coupon is transmitted in the push form, and the authentication number of the online commodity coupon corresponding thereto can employ a confirmable method based on a pull form through code or number input and uniform resource locator (URL) direct input. In addition, a description of the online commodity coupon, information on a person giving the gift, and the franchise information can be also transmitted.

<Authenticating Online Commodity Coupon and Purchasing Real Goods>

Referring to FIG. 7, the user (purchaser or receiver) completing the purchasing and registering of the online commodity coupon through the above process visits a predetermined franchise, and shows the authentication number of the his/her receiving online commodity coupon to the person in charge of the franchise (Step 70).

After that, if the person in charge inputs the authentication number of the online commodity coupon to the communicatable franchise communication terminal such as a VAN terminal or PC, a POS, and a wireless terminal, the franchise communication terminal transmits the received authentication number to the commodity coupon server, and confirms whether or not the authentication number inputted from the franchise communication terminal is consistent with the authentication number previously stored in the commodity coupon server, thereby performing authentication (Steps 71 to 73).

As a result, upon authentication success, an acknowledgement result of “authentication success” is transmitted to the franchise communication terminal and, upon authentication failure, guidance message information of “authentication failure” is transmitted and confirmed, and the process is ended (Step 74 and 79).

In case where the acknowledgement result is transmitted, the specific commodity information and franchise information corresponding to the online commodity coupon are transmitted to the franchise communication terminal and are displayed together with the acknowledgement result (Steps 75 and 76). In an exemplary embodiment, in case where the online commodity coupon is a free ticket for a pizza of 20,000 won, as shown in FIG. 8, it is displayed and informed that the communication terminal of the franchise acknowledging the online commodity coupon has number of “XXX-XXXX”, the authentication number of the acknowledged online commodity coupon is “01FG79PH2”, the transaction goods of the online commodity coupon has a class of “free ticket for pizza”, the transaction money is “\20,000”, and the authentication result is acknowledged as “authentication success”.

After the confirming of the displayed information, the franchise distinguishably processes through its installed communication terminal such as a POS or a VAN terminal to subtract or pay the transaction money so that money charged for the specific commodity which the user intends to purchase amounts to “0 won”, and then supplies the specific commodity corresponding to the online commodity coupon to the user (Step 77).

This is to facilitate settlement of accounts and statistic processing for the real goods sold later.

Last, the franchise transmits the information on the authenticated online commodity coupon to the commodity coupon server and informs that the specific commodity is transacted, and the commodity coupon server updates the information and defines the online commodity coupon as one time use (Steps 77 and 78). In other words, if the online commodity coupon is authenticated one time, it is recorded that the online commodity coupon authenticated in the commodity coupon server is used, and, when the same authentication number is later transmitted, an authentication failure message is transmitted, thereby preferably preventing the online commodity coupon from being used by stealth.

As described above, in the present invention, there is an effect in that the commodity coupon which can exchange for and purchase only the specific commodity is online purchased and transmitted to the other users, and the receiving users can be authenticated in the franchise and allowed to purchase the specific commodity, thereby making it possible to perform a new concept of real transaction management unlike a conventional online merchandise coupon based on a cash concept, and being convenient in keeping and use of the commodity coupon, and enabling use of any user carrying the wireless terminal.

Further, there is an effect in that effectiveness of the commodity coupon online issued can be authenticated and the specific commodity corresponding to the authenticated commodity coupon can be purchased, thereby preventing the use by stealth of the commodity coupon, and allowing the user to be easily authenticated for and use the commodity coupon through the wireless terminal without the separate device.

Furthermore, there is an effect in that the online commodity coupon is designated to exchange for or purchase only the specific goods intended for purchase, thereby giving anticipation to the purchaser or the client and maximizing satisfaction for the supplied goods.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A goods purchasing system using an online commodity coupon, the system comprising:
a first terminal registered to an online service for purchasing the commodity coupon that can exchange for or purchase only specific goods through the online service;
at least one communicatable second terminal for receiving the online commodity coupon from the first terminal;
a commodity coupon server for online providing a commodity coupon issuance service, databasing a variety of information on the issued commodity coupon, and connecting with the first terminal and the at least one second terminal through a communication network; and
a franchise for connecting with the commodity coupon server through the communication network and confirming effectiveness or noneffectiveness of the online commodity coupon received at the second terminal, and, after the effectiveness of the online commodity coupon is confirmed, supplying a specific commodity corresponding to the online commodity coupon to a user of the second terminal.

2. The system of claim 1, wherein the online service is a homepage based community or one-person media service, a messenger service, and a portal service.

3. The system of claim 1, wherein the online commodity coupon is purchased by any one of settlements based on cyber money held by each purchaser through the online service, a credit card, and a mobile communication terminal.

4. The system of claim 1, wherein the first terminal and the at least one second terminal are portable wireless terminals.

5. The system of claim 1, wherein the first terminal is a wired/wireless terminal, and the at least one second terminal is a portable wireless terminal.

6. The system of claim 1, wherein the online commodity coupon transmitted from the first terminal to the at least one second terminal is transmitted through the commodity coupon server.

7. The system of claim 1, wherein the commodity coupon server comprises:
a terminal information database comprising information on the franchise, information on the first and second terminal, and user identification and cyber money information;
a commodity coupon information database for storing information on an authentication number of the issued online commodity coupon, transaction goods, and transaction money, based on information on the specific commodity;
an authentication processing module for, upon receipt of the authentication number of the online commodity coupon from a communication terminal of the franchise, comparing the received authentication number with information stored in the commodity coupon information database and processing authentication of the online commodity coupon;
a commodity coupon transmitting module connecting with the authentication processing module and, upon issuance of the online commodity coupon, transmitting the issued online commodity coupon to the terminal on the basis of terminal or second terminal information stored in the terminal information database; and
a purchase processing module connecting with the authentication processing module, and processing purchase of goods in each franchise depending on authentication or nonauthentication of the online commodity coupon.

8. The system of claim 7, wherein the commodity coupon server further comprises a login information database for, in order to confirm an owner of the online commodity coupon, storing inherent password information of the second terminal user and, in case where the user uses the online commodity coupon, performing selective user authentication.

9. The system of claim 1, further comprising a VAN (value added network) service provider server for enabling mutual communication through a VAN network between the commodity coupon server and the franchise.

10. A goods purchasing method using an online commodity coupon, the method comprising:
a first step of, by a purchaser previously registered to an online service, purchasing an online commodity coupon that can online exchange for and purchase only specific goods, through a communicatable terminal;
a second step of registering the purchased online commodity coupon to a commodity coupon server, and receiving details information of a specific commodity that corresponds to the registered commodity coupon, from the commodity coupon server;
a third step of purchaser's selecting whether or not he/she transmits the registered online commodity coupon to other users;
a fourth step of, by the purchaser himself/herself or other users receiving the online commodity coupon from the purchaser, visiting a franchise and confirming effectiveness or noneffectiveness of the online commodity coupon;
a fifth step of, as a result of confirming the effectiveness or noneffectiveness, if authentication of the online commodity coupon succeeds, supplying a specific commodity by the franchise; and
a sixth step of transmitting and updating authentication result information and use information on the online commodity coupon to the commodity coupon server.

11. The method of claim 10, wherein, when the purchaser purchases the online commodity coupon in the first step, he/she purchases the online commodity coupon by applying for a premium provided in the online service, or connects to a specific Web site connecting with the online service and directly purchases the online commodity coupon using a cyber money held by each purchaser, a credit card, and hand phone settlement.

12. The method of claim 10, further comprising the step of, when the purchaser transmits the online commodity coupon to other users in the third step, inputting a terminal telephone number of the user, or detecting information on a user previously registered to the commodity coupon server and transmitting the detected information to the terminal.

13. The method of claim 10, wherein, when the purchaser transmits the online commodity coupon to himself/herself or other users, an authentication number given to the online commodity coupon is transmitted from the commodity coupon server to the purchaser himself/herself or the user in a push form using a previously stored telephone number, or transmission or nontransmission of the online commodity coupon is transmitted in the push form and the authentication number of the online commodity coupon is confirmable in a pull form.

14. The method of claim 10, wherein the fourth step of confirming whether or not the online commodity coupon is effective depends on whether or not the authentication number of the online commodity coupon transmitted to the purchaser himself/herself or the user is consistent with authentication number information databased in the commodity coupon server.

15. The method of claim 14, wherein, in case where the authentication number of the online commodity coupon is consistent, the online commodity coupon is updated in the commodity coupon server as being one-time authenticated and used, and an authentication message is transmitted from the commodity coupon server to the franchise, and
after one-time authentication, in case where the same authentication number is transmitted to the commodity coupon server, an authentication failure message is transmitted to the franchise.

16. The method of claim 10, wherein in the fifth step, the franchise subtracts transaction money for the specific commodity and distinguishably processes charge money as “0 won”.

17. The method of claim 16, wherein the communication terminal is a POS (point of sales) or a VAN (value added network) terminal.
